(19) United States
(12) Patent Application Publication
(10) Pub. No.: US 2011/0052023 A1
(43) Pub. Date: Mar. 3, 2011

(54) Reconstruction of Images Using Sparse Representation

(75) Inventors: Rahul Garg, Yorktown Heights, NY (US); Rohit Madhukar Khandekar, Elmsford, NY (US); Charles Clyde Peck, III, Newtown, CT (US); Nils Petter Smeds, Farsta (SE)

(73) Assignee: International Business Machines Corporation, Armonk, NY (US)

(21) Appl. No.: 12/549,964

(22) Filed: Aug. 28, 2009

(51) Int. Cl. G06K 9/36; G06K 9/32

(52) U.S. Cl. 382/131; 382/286; 382/294

(57) ABSTRACT

A method for reconstructing an image includes steps of obtaining a measurement in a first domain, generating an estimate of the image in a second domain based at least in part on the measurement, generating a sparse representation in a third domain based at least in part on the estimate, and performing one or more iterations until the estimate is determined to satisfy one or more image quality criteria. A given iteration includes steps of generating a projection in the first domain based at least in part on the sparse representation, updating the sparse representation based at least in part on the projection, and updating the estimate based at least in part on the sparse representation. The method further includes a step of outputting the estimate determined to satisfy the one or more image quality criteria for use as the image.

### FIELD OF THE INVENTION

The present invention relates generally to reconstruction of images and, more particularly, to techniques for reconstructing two- and three-dimensional images such as medical images.

### BACKGROUND OF THE INVENTION

The process of image reconstruction is based on observing the effect the object under investigation has on the detector activity in the scanning equipment. This indirect method of determining the full two-dimensional (2D) or three-dimensional (3D) structure of the examined object needs to make several assumptions and simplifications about the physical processes that lead to detector activity. The reconstruction algorithms using complete and accurate physical models are computationally expensive. For tractability purposes, several simplifications are made in underlying physical models.

The image reconstruction process is usually formulated as a mathematical optimization problem. The optimal solution to the problem is a (typically 3D) image of the object under investigation. Most image reconstruction algorithms strive to give solutions that are “numerically close” to the desired image of the object (by minimizing the squared error or maximizing the likelihood function). However, the observer (e.g., the doctor, in the case of medical images) may be interested in other aspects of an image that are not directly related to the objective function being optimized by the reconstruction algorithm (e.g., tumor contrast in specific regions of interest, partial volume effect, quantitative accuracy, etc.).

### SUMMARY OF THE INVENTION

Principles of the invention provide techniques for reconstructing images such as 2D or 3D images. While not intended to be limited thereto, such techniques are particularly suitable for application to medical images.

For example, in one aspect, a method for reconstructing an image includes steps of obtaining a measurement in a first domain, generating an estimate of the image in a second domain based at least in part on the measurement, generating a sparse representation in a third domain based at least in part on the estimate, and performing one or more iterations until the estimate is determined to satisfy one or more image quality criteria. A given iteration includes steps of generating a projection in the first domain based at least in part on the sparse representation, updating the sparse representation based at least in part on the projection, and updating the estimate based at least in part on the sparse representation. The method further includes a step of outputting the estimate determined to satisfy the one or more image quality criteria for use as the image.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary embodiment of an image acquisition system within which an illustrative embodiment of the present invention may be implemented.

FIG. 2 shows an exemplary image generation process within which an illustrative embodiment of the present invention may be implemented.

FIG. 3 shows an exemplary process for sketch partitioning according to an embodiment of the invention.

FIG. 4 shows a computer system that may be useful in implementing one or more aspects and/or elements of the invention.

### DETAILED DESCRIPTION OF PREFERRED EMBODIMENTS

FIG. 1 shows an exemplary embodiment of an image acquisition system within which an illustrative embodiment of the present invention may be implemented. The exemplary system includes an imaging device 110, which may be, for example, a scanner or a camera. Imaging device 110 may be operative to implement a medical imaging technique such as, for example, Positron Emission Tomography (PET), Single Photon Emission Computed Tomography (SPECT), Computed Tomography (CT), Magnetic Resonance Imaging (MRI), Nuclear Magnetic Resonance Imaging (NMRI), or High-Resolution Research Tomography (HRRT). However, illustrative embodiments of the present invention may be utilized with a broad range of imaging techniques suitable for any number of applications.

Although the illustrative embodiments herein utilize two-dimensional matrices of real numbers, the techniques herein may be utilized with any systematic arrangement of numeric values. The term “array” as used herein is to be construed broadly to include any systematic arrangement of numeric values including but not limited to one-dimensional vectors, two-dimensional matrices, and three-dimensional tensors. Moreover, the numeric values stored within such arrays may comprise, for example, real numbers, complex numbers, or may themselves be arrays of numeric values.

Imaging device 110 may be attached to a data acquisition system 120, either directly (e.g., via a cable or bus) or indirectly (e.g., via a wired or wireless communication network). In an exemplary embodiment, imaging device 110 generates raw data which is acquired and stored in raw files, either directly in a local storage 125 (e.g., a hard disk) of acquisition system 120 or to a storage (e.g., 145) connected to a communication network (e.g., 130). In one embodiment, imaging device 110 and data acquisition system 120 may be components of a single computing system.

A reconstruction system 140 typically receives the aforementioned raw data from data acquisition system 120 via communication network 130. Alternatively, however, reconstruction system 140 may be directly coupled to data acquisition system 120 (e.g., via a cable or bus), or a single computer system may be used to implement the functionality associated with both data acquisition system 120 and reconstruction system 140.

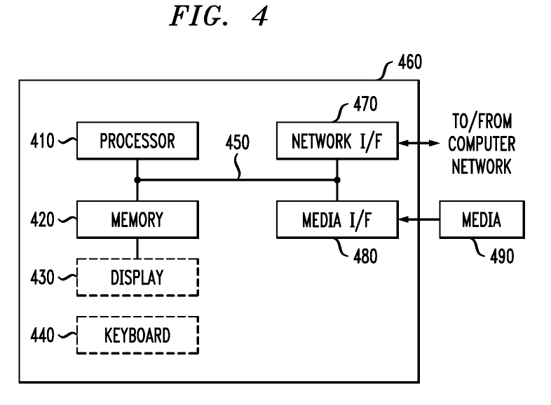

Reconstruction system 140 may run one or more data pre-processing programs, image reconstruction programs and/or visualization programs. These pre-processing programs may take the raw data files as input and generate output files suitable for further processing by reconstruction programs, which take these pre-processed (or raw) files as input and produces image files as output. These image files may be later used to visualize the object being imaged and/or to derive quantitative measurements or biological markers or relevance. Reconstruction system 140 may also be connected to an accelerator system 150, which may be, for example, a general-purpose parallel system or a special purpose accelerator made of GPUs, Cell processor, FPGAs and/or other specialized devices. In one embodiment, data acquisition system 120, reconstruction system 140, and accelerator system 150 may each have a structure similar to that discussed hereinbelow with reference to FIG. 4. In an illustrative embodiment, the techniques described hereinbelow are implemented primarily in reconstruction system 140 and/or accelerator system 150; however, this is not a requirement of the invention.

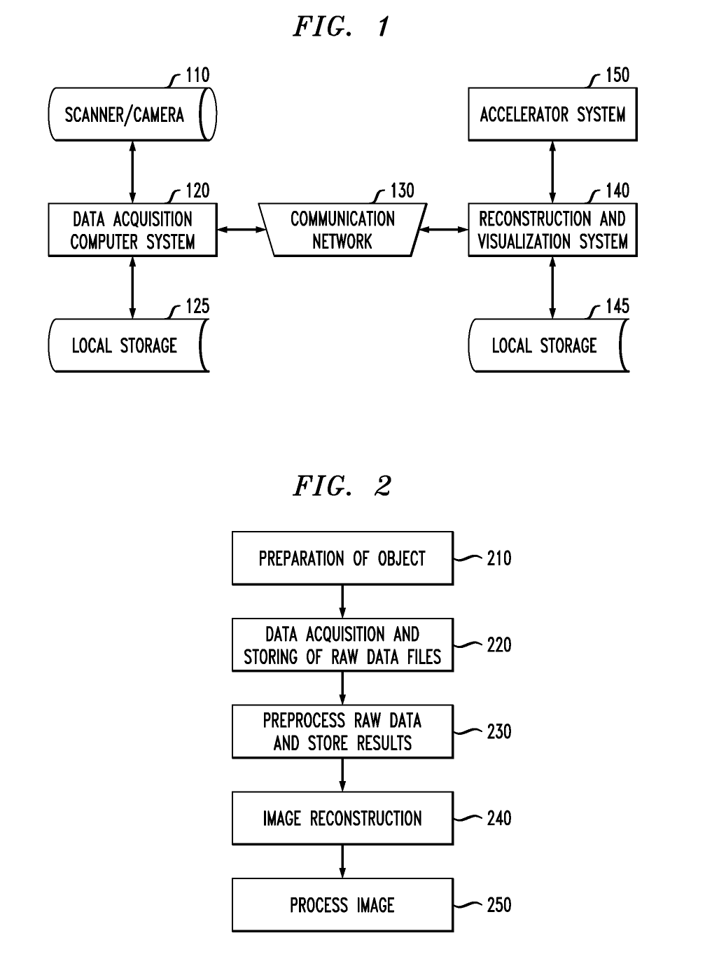

FIG. 2 shows an exemplary image generation process within which an illustrative embodiment of the present invention may be implemented. The process begins in step 210, during which the object under investigation is prepared, typically so as to carry out a desired protocol. Step 210 may include, for example, bringing the object within the field-of-view of the image acquisition device (e.g., 110 in FIG. 1) and positioning the object so as to be properly positioned in the field-of-view of the image acquisition device. Where a person is being imaged (e.g., as part of a medical imaging procedure), step 210 may include instructing the person to perform or refrain from performing certain tasks (e.g., to hold still during the imaging). Step 210 may also involve injecting a tracer or starting various measurements.

In step 220, an acquisition program, which may run on acquisition system 120 in FIG. 1, stores the data generated by the image acquisition device (e.g., 110 in FIG. 1) into one or more raw files. In step 230, pre-processing programs may take the raw data files as input and write intermediate preprocessed files for use in subsequent image reconstruction. In the embodiment shown in FIG. 1, these pre-processing programs may run on, for example, acquisition system 120 and/or reconstruction system 140. To save time, these program may also be active while the data acquisition is being done (e.g., steps 220 and 230 may be performed simultaneously rather than sequentially).

In step 240, an image reconstruction program, such as that discussed hereinbelow, takes the preprocessed files as input and produces image files that are used by other programs for subsequent image processing (step 250). With reference to FIG. 1, the reconstruction program is usually run in reconstruction system 140 and/or accelerator system 150. The image processing performed in step 250 may include, for example, displaying the images, visualizing the images, extracting markers and/or other relevant information about the object, drawing conclusions and/or generating printouts.

The image reconstruction process performed in step 240 may be formulated as a mathematical optimization problem. More formally, x*ε [symbol] ⁿ is defined as an idealized image domain representation of an object to be imaged. x* consists of n real numbers, where each number n may represent an intensity value in a given spatial region of the object, such as a given region within a two- or three-dimensional grid.

An image acquisition system (e.g., 120 in FIG. 1) measures a linear combination of the intensity values in x*. An ideal system with m measurements would measure the values yᵢ^{ideal}=Σⱼ₌₁ⁿpᵢⱼ^{ideal}x*ⱼ for i in the range 1 . . . m, where y is used to represent a vector of m real-numbered observations and P represents a n×m real-numbered projection matrix (or system matrix) with entries pᵢⱼ. This system matrix is associated with a given image acquisition device and may be derived from, for example, the geometry of the device, geometry, various physical, chemical, biological and electrical/electronic processes involved in the measurement process, physical, chemical and biological processes taking place in the object under investigation and the physical, chemical and biological processes resulting from the interaction of the device and the object under investigation.

However, the actual measurements are corrupted by noise eᵢ. Thus, the imaging system ends up measuring yᵢ=Σⱼ₌₁ⁿpᵢⱼx*ⱼ+eᵢ, where e represents a vector of m stochastic processes denoting the noise in the measurements.

In a real system, an accurate statistical characterization of noise e, may not be available. Moreover, the projection matrix P may not be known very accurately, or may have to be simplified for computational tractability. So instead, an approximate statistical model for the noise using parameters e¹, e², . . . and an approximate model P of P^{ideal} is the typical representation of the measurement device. Thus, an imaging system with m measurements is modeled as measuring the values yᵢ=Σⱼ₌₁ⁿpᵢⱼx*ⱼ+eᵢ for values of j in 1 . . . m. The error processes are parametrized using the m-dimensional vectors of real numbers e¹,e², . . . and are obtained using the output of the scanning system.

An illustrative embodiment of the invention generates x, which estimates the “true image” x* using the measurements y, an estimate of noise parameters e¹,e², . . . and the projection matrix (also called the system matrix) P. The reconstructed image x contains much more information relevant to the observer about x* than other methods that estimate x*, which usually reconstruct images that are numerically closer to x*. It is more important to reconstruct an image x that has more information relevant to observer than an image that is numerically closer to x*.

In an exemplary embodiment, the image x* is modeled as a linear combination of a relatively small number of image components from a large set of candidate image components. This is called the sparse representation in the transformed domain, in which the image x is represented in a new space given by k matrices T₁,T₂, . . . , Tₖ using k vectors g₁,g₂, . . . , gₖ, such that x=T₁g₁+T₂g₂+ . . . +Tₖgₖ. Here Tᵢ is a matrix of size n×tᵢ, and gᵢ is a vector of size tᵢ×1 for i=1, 2, . . . , k. Columns in the matrices T₁, . . . , Tₖ are the candidate image components by which the full image may be represented. The vectors g₁, . . . , gₖ are the representation of the image x in the new basis. The non-zero entries in g₁ . . . gₖ correspond to the image components that are present in x. Let t=t₁+t₂+ . . . +tₖ, T be a matrix of size n×t (where t=t₁+t₂+ . . . +tₖ) obtained by including all the columns of the matrices T₁,T₂ . . . Tₖ i.e., T=[T₁T₂ . . . Tₖ] and let g be a vector of size t×1 given by stacking g₁,g₂, . . . , gₖ into a single vector. Thus, the reconstruction problem can be written as y=PTg. Examples of matrices (T's) that may be used for sparse representation include:

(i) Matrices representing invertible and non-invertible linear transformations used in the image and signal processing. These include different types of matrices representing one-dimensional, two-dimensional and three-dimensional inverse discrete cosine transform (DCT), or matrices representing one-dimensional, two-dimensional and three-dimensional inverse discrete wavelet transform using various other wavelet functions, including the HAAR transform, Meyer, Morlet and Mexican Hat wavelet. Examples of such functions are described in Rafael C. Gonzalez and Richard E. Woods, Digital Image Processing (3rd Edition), Prentice Hall, August 2007; and Stephane Mallat, A Wavelet Tour of Signal Processing, Second Edition (Wavelet Analysis & Its Applications), Academic Press, September 1999, the disclosures of which are incorporated by reference herein.

(ii) Matrices where each column represents a component of known structure present in the object being imaged. Some examples of these structures, in a medical imaging context, would include different sub-components of a heart, brain and other parts of the body.

(iii) Image components. For example, a parametric representation of the current image estimate may be obtained from segmentation of the current image or from suitable perturbations (such as movements and deformations) of image components.

An illustrative embodiment of the present invention seeks to solve a fundamental problem of image reconstruction which is widely referred to as the inverse problem. This problem can be characterized as finding an appropriate fit x to the system of m equations represented in the matrix form as y=Px+e. The algorithm used to find a suitable solution to the above set of equations is called the reconstruction algorithm.

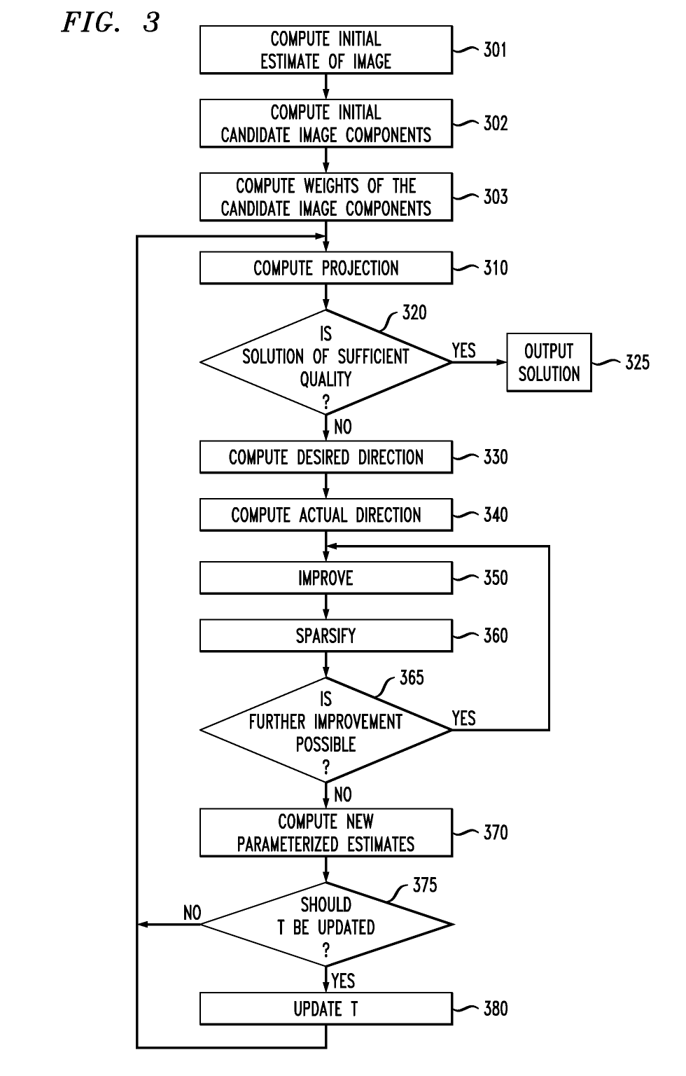

FIG. 3 shows an exemplary iterative algorithm which is used to find a sparse solution in the transformed domain according to an illustrative embodiment of the present invention. The exemplary algorithm begins with three initialization steps, denoted as steps 301, 302 and 303.

In step 301, an initial estimate of the image x⁰ is computed. The initial estimate could be an image where all the values are set to a fixed constant c (e.g., 0 or 1). Alternatively, an initial estimate could be obtained by running an algorithm such as three-dimensional ordered set expectation maximization (OSEM-3D) on the input data. In step 302, initial candidate image components (i.e. an initial set T⁰ of the transformation matrix T) are computed; preferably, this initial value T⁰ of the matrix T is derived from a sparse representation as discussed above. In one embodiment, the candidate image components are chosen to represent the features of interest to the observer, such that the sparse representation of the image using small number of candidate image components advantageously results in more accurate reconstruction of features which are of interest to the observer, while ignoring features that of less importance to the observer.

In step 303, the weights w of the candidate image components are computed. The initial weights w could be initialized to a constant (such as 1) or they could be read from a file. Alternatively, the initial weights w could be obtained by estimating the L2 norm of the columns of the matrix PT⁰. The L2 norm may be estimated by taking sequence of unit norm random vectors rⁱε [symbol] ^{m} for iε[1 . . . l] and computing zⁱ=T^{T}P^{T}rⁱ. The vector w given by

$${w}_{j} = {( \frac{m}{l} {\sum }_{i = 1}^{l} {z}_{j}^{i} \cdot {z}_{j}^{i} )}^{1 / 2}$$

gives an estimate of the L2 norm of the columns of PT. The columns of PT are preferably scaled so that they have (approximately) unit norm. The new matrix is given by T=T⁰W where W=diag(1/w₁, 1/w₂, . . . ), is the diagonal scaling matrix.

In the remaining steps, this initial image is refined successively to get better estimates of x*. In each iteration k≧0, the algorithm computes in step 310 a projection y^{k}=PT^{k}x^{k} and, optionally, a residue r^{k}=ƒ₁(y,y^{k},e¹,e², . . . ). In one embodiment, computing the projection (y^{k}=PT^{k}g^{k}) involves two matrix-vector multiplications—one for computing x^{k}=T^{k}g^{k} and the other for computing y^{k}=Px^{k}. Both these steps may be parallelized by either assigning the rows and/or columns of the matrices P and T to different processors.

The first step of computing x^{k}=T^{k}g^{k} may be carried out using a combination of simple parallel matrix multiplications on sub-matrices of T^{k} and efficient parallel algorithms to compute certain transforms (such as Fast Fourier Transform (FFT) or parallel Discrete Wavelet Transform) represented by other sub-matrices of T. For example, the columns of the matrix T may be separated into sub-matrices T₁,T₂, . . . Tₖ such that some of the sub-matrices represent well-known linear algebra transformations (such as DCT or Wavelet transforms) used in signal and image processing. Algorithms and transformations suitable for use in this step include those described in Matteo Frigo and Steven G. Johnson, “The Design and Implementation of FFTW3,” Proceedings of the IEEE, 93(2):216-231, 2005, the disclosure of which is incorporated herein, as well as the Mallet reference cited above.

Commonly known parallel algorithms can then be used to compute the corresponding products xₗ=Tₗgₗ. Examples of such algorithms are described in, for example, Dilip Krishnaswamy & Michael Orchard, “Parallel algorithms for the two-dimensional discrete wavelet transform,” in ICPP '94: Proceedings of the 1994 International Conference on Parallel Processing, pages 47-54, Washington, D.C., USA, 1994. IEEE Computer Society; Tarek A. El-Ghazawi et al., “Wavelet-based Image Registration on Parallel Computers,” in Proceedings of the 1997 ACM/IEEE conference on Supercomputing (SC'97), November 1997; and Tarek A. El-Ghazawi & Jacqueline Le Moigne, “Performance of the Wavelet Decomposition on Massively Parallel Architectures,” International Journal of Computers and Applications, 27(2):72-81, 2005, the disclosures of which are incorporated by reference herein.

The other columns of the matrix T may then be suitably assigned to the processors. The corresponding entries of the vector g are also distributed. Each processor carries out its part of the work to compute Tₗgₗ. Finally, the computations xₗ=Tₗgₗ are summed up to give x=Σₗ₌₁^{k}Tₗgₗ, using collective operations, which could, for example. be implemented using Message-Passing Interface (MPI) or Parallel Virtual Machine (PVM).

The second step of computing y^{k}=Px^{k} is widely referred to as the projection step in most of the image reconstruction literature. Preferably, the vector Px is computed in parallel. If the matrix P can be stored in memory, then matrix multiplication algorithms and implementations may be used for efficient parallel computation including, for example, LAPACK or ScaLAPACK.

Note that it might be impossible to explicitly store the matrix P even on a large supercomputer. Thus, an illustrative embodiment does not require the projection matrix P to be stored explicitly. Rather, the matrix P may be computed on-the-fly or implicitly and the current image estimates may be used to refine P. This product may be computed on-the-fly using techniques such as the ones described in, for example, I. K. Hong et al., “Ultra Fast Symmetry and Simd-based Projection-Backprojection (SSP) Algorithm for 3-D PET Image Reconstruction,” IEEE Trans. Med. Imaging, 26(6):789-803, 2007, the disclosure of which is incorporated by reference herein. If the matrix P is computed on-the-fly, then either different rows or columns may be assigned to different processors, which could then independently multiply sub-matrices of P with x. These results could then be aggregated to form the projection Px=PTg.

In step 320, a “goodness test” of the current image estimate x^{k} is carried out to determine whether the image has converged to the desired quality and hence satisfies image quality criteria. This test may use the current image estimate x^{k} and/or the residue r^{k}. For example, the test may include one or more of the following:

(i) Checking that a desired number of iterations has been performed.

(ii) Checking that a suitable measure of error given by z^{k}=ƒ₄(y,y^{k},e, . . . ) is small enough. One possible choice of the function ƒ₄ is the L-q norm function given by ƒ₄(y,y^{k},e¹)=(Σⱼ₌₁^{m}(|yⱼ−e¹−y^{k}ⱼ|)^{q})^{1/q}.

(iii) Monitoring the change in the error from the last iteration and interrupting the computation if it is smaller than a certain threshold εₜₕ, ∥z^{k-1}−z^{k}∥<εₜₕ

(iv) Evaluating the image quality given by q^{k}=ƒ₅(y,y^{k},e¹, . . . ) and comparing it to a suitable conversion criterion.

(v) Monitoring the improvement in image quality from the last iteration and interrupting the computation if it is smaller than a certain threshold εₜₕ, ∥q^{k}−q^{k-1}∥<εₜₕ.

If the current image estimate is found to be “good” enough, then the algorithm stops in step 325, and outputs the current image estimate x^{k}. However, if the current image estimate is not good enough, then a “desired direction of improvement” is computed in step 330. This “desired direction of improvement” may be computed using one or more of the current projection y^{k}, the observations y, the current image estimates x^{k} and g^{k}, the error parameters e¹,e², . . . , the current matrix of transformations T^{k}, the projection matrix P and some auxiliary parameters using d^{k}=ƒ₂(y,y^{k},x^{k},g^{k},e¹,e², . . . , T^{k},P,parameters). The function may thus be, for example, based on the measurements, the system matrix of the image acquisition device and information about various physical, chemical and biological processes involved in object under investigation, measurement device and their interactions.

For example, the desired direction of improvement may be computed using the gradient of a function v=ƒ₆(y,y^{k},e¹, . . . , g^{k},T^{k},P,parameters) with respect to the vector g. If the function ƒ₆ is not differentiable, the desired direction may be found by computing a sub-gradient of the function ƒ₆ at the current solution. Alternatively, the desired direction of improvement may be found as a vector v such that v^{T}∇ƒ₆<0 where ∇ƒ₆ represents a sub-gradient of the function ƒ₆ with respect to g at its current solution. The function ƒ₆ may, for example, take one of the following forms:

(i) Squared error function, e.g.: ƒ₆(y,e,g,T,P)=∥y−e−PTg∥₂²

(ii) Negative Log-likelihood function, e.g.: ƒ₆(y,e,g,T,P)=(PTg+e)^{T}1^{m}−Σᵢ₌₁^{m}yᵢ log ([PTg+e]ᵢ), where 1^{m} represents the m-dimensional vector with all ones and [PTg]ᵢ represents the i^{th} component of the vector PTg.

(iii) Squared error function with penalty: ƒ₆(y,e,g,T,P)=∥y−e−PTg∥₂²+ƒ₇(g) where the penalty function ƒ₇(g) could be, for example, the L-q norm function given by ƒ₇(g)=(Σᵢ₌₁^{t}|^{q})^{l/q}. Typical choices are q=1 for sparsity and q=2 for smoothness. One may use other functions such as a weighted combination of L-1 and L-2 norm (e.g., an Elastic Net algorithm such as that described in Hui Zou & Trevor Hastie, Regularization and Variable Selection via the Elastic Net, Journal of the Royal Statistical Society B, 67:301-320, 2005, the disclosure of which is incorporated by reference herein), or the maximum norm (L_{∞}) etc.

(iv) Negative Log-likelihood function with penalty: The function is ƒ₆(y,e,g,T,P)=(PTg+e)^{T}1^{m}−Σᵢ₌₁^{m}yᵢ log ([PTg+e]ᵢ)+ƒ₇(g), thereby combining the likelihood function discussed in (ii) above and the penalty function discussed in (iii) above.

The gradient for the squared error function is given by ∇ƒ₆=T^{T}P^{T}(y−e−PTg). This may be computed by a “back-projection” step applied to the residual vector r^{k} computed as r^{k}=y−e−y^{k}, where y^{k}=PTg^{k} as computed in step 310. The back-projection step computes the vector P^{T}r^{k} from the vector r^{k} using known methods. Since the matrix P may be large and not explicitly stored in the memory, the product may be computed on the fly using techniques known by one skilled in the art, as discussed above with reference to step 310.

The gradient may be computed as d^{k}=T^{T}(P^{T}r^{k}) using explicit parallel matrix multiplication with sub-matrices of T and efficient parallel algorithms to compute certain transforms (such as inverse Fast Fourier Transform (FFT) or parallel inverse discrete wavelet transform (DWT)) represented by other sub-matrices of T.

In a similar way, the gradient of log-likelihood function may be computed by simple matrix-vector and vector-vector operations on matrices P,T,P^{T},T^{T} and g. The operations involving the matrix P may be done using parallel projection and back-projection steps. The operations involving the matrix T may be done using a combination of parallel matrix operation on sub-matrices of T and efficient algorithms to compute various transforms (such as FFT or DWT, as discussed above) on other sub-matrices of T.

Computing sub-gradients of the likelihood functions with L-q penalties (q>1) can also be done using matrix operations on P,T,T^{T},P^{T} and g as before. For functions involving a L-1 penalty term, a sub-gradient may be computed by applying a hard-thresholding operation to the gradient of the corresponding function without the penalty term.

It may be desirable for this computation of the back-projection to be parallelized to run efficiently on high-performance parallel systems comprising many processors. For the computation of x=P^{T}r, the columns or rows of the matrix P may be assigned to different processors, which independently carry out the product on sub-matrices of P. The results on different processors could then be aggregated to give the product x=P^{T}r To compute g=T^{T}x, the columns of matrix T are divided into transformations (as in the projection steps) and other candidate image components. The transformations are carried out using efficient parallel algorithm already known in the literature. The remaining columns are distributed to different processors which independently compute gₗ=Tₗ^{T}x. The results are aggregated to give g=T^{T}P^{T}r.

The desired direction computed in step 330, however, may not be suitable for several reasons. For example, moving in the desired direction may violate some constraints in the constrained optimization, or may violate the sparsity of the current solution. Therefore an “actual direction of movement” is computed in step 340 as a function of the desired direction d^{k}, current solution (x^{k},g^{k}) and some additional parameters: a^{k}=ƒ₃(d^{k},x^{k},g^{k},parameters), where there are several choices of the function ƒ₃ that may be used. For example, computing an actual direction of movement, while preserving sparsity of the solution, may include the use of soft thresholding and/or hard thresholding.

Soft thresholding with a parameter λ≧0 replaces each coefficient aᵢ, in the actual direction a=a^{k} by S_{λ}(dᵢ^{k}) where the function S_{λ}: [symbol] → [symbol] is defined as

$${S}_{λ} ( u ) = \{ \begin{matrix}u - λ , & if u \geq λ ; \\ 0 , & if - λ < u < λ ; \\ u + λ , & if u \leq - λ .\end{matrix}$$

Hard thresholding with a parameter λ≧0, on the other hand, replaces each coefficient aᵢ in the actual direction a=a^{k} by S_{λ}(dᵢ^{k}) where the function S_{λ}: [symbol] → [symbol] is defined as

$${S}_{λ} ( u ) = \{ \begin{matrix}u , & if u \leq - λ or u \geq λ ; \\ 0 , & if - λ < u < λ .\end{matrix}$$

In effect, such thresholding sets small coefficients in the direction to zero in order to preserve sparsity of the current solution.

In step 350, a new image estimate (in the sparse representation) is obtained by moving in the direction a^{k} as follows: ĝ^{k+1}=g^{k}+l*a^{k}. The parameter l is called the step length of this movement which depends again on the current solution and several parameters of the problem. This improve step 350 may modify the current solution (in the sparse representation) g^{k} using the actual direction of improvement a^{k} using, for example, a multiplicative or an additive update. A multiplicative update computes the new solution g′^{k} using the actual direction of improvement (a^{k}) as g′ᵢ^{k}=gᵢ^{k}(1+αaᵢ^{k}). An additive update computes the new solution g′r^{k} using the actual direction of improvement (a^{k}) as g′ᵢ^{k}=gᵢ^{k}+αaᵢ^{k}.

The solution ĝ^{k+1} computed in step 350 may not be sparse, however. As such, it may be desirable to perform a “sparsification” step 360 which reduces the number of non-zero entries in the current solution ĝ^{k+1} without changing it significantly. For example, some of the coefficients of g′^{k} are set to zero. Soft thresholding or hard thresholding (discussed earlier with reference to step 340) may be used for the sparsification step.

Weighted versions of hard thresholding may also be used. Weighted hard thresholding with a parameter λ≧0, and a weight vector w replaces each coefficient gᵢ, by S_{λ}(gᵢwᵢ) where the function H_{λ}: [symbol] ²→ [symbol] is defined as

$${H}_{λ} ( u , w ) = \{ \begin{matrix}u , & if \vert u \vert \vert w \vert \geq λ ; \\ 0 , & otherwise .\end{matrix}$$

Some useful weight vectors for this step may include the use of the gradient vector, desired direction of improvement or actual direction of improvement.

It may be desirable to perform a sequence of alternating improvement and sparsification steps (350 and 360, respectively) until the current solution cannot be improved (step 365).

In step 370, several image components are extracted from the current estimate of image. These components are represented in a parametric form and then perturbed to generate several candidate image components. More particularly, the current solution becomes the next solution g^{k+1} in the sparse representation, the actual image estimate is computed using x^{k+1}=T^{k}g^{k+1} and these image estimates x^{k+1} and g^{k+1} are used to compute a new parametrized representation. It may be desirable to segment the image, then partition the image into several image components which could then be represented using mathematical models. These candidate image components can then be used to modify the transform domain representation.

Examples of techniques which could be used for this segmentation are discussed in, for example, Jasjit S. Suri et al., eds., Advanced Algorithmic Approaches to Medical Image Segmentation State-of-the-art Application in Cardiology, Neurology, Mammography and Pathology. Springer-Verlag New York, Inc., New York, N.Y., USA, 2002; Jasjit S. Suri et al., Handbook of Biomedical Image Analysis: Volume 1: Segmentation Models Part A (Topics in Biomedical Engineering International Book Series). Springer-Verlag New York, Inc., Secaucus, N.J., USA, 2005; and Terry S. Yoo. Insight into Images: Principles and Practice for Segmentation, Registration, and Image Analysis, AK Peters Ltd, 2004, the disclosures of which are incorporated by reference herein.

Likewise, the mathematical models used to represent image components may include representations using polynomial, sine/cosine, other trigonometric functions, logarithmic/exponent, other mathematical functions and their combinations. Examples of such representations include triangulation, mesh generation and other techniques used in computer vision, graphics and other areas, such as those described in Linda G. Shapiro and George Stockman, Computer Vision, Prentice Hall, January 2001; Peter Shirley et al., Fundamentals of Computer Graphics, 2d ed., A. K. Peters, Ltd., Natick, Mass., USA, 2005; and Richard M. Lueptow, Graphic Concepts for Computer Aided Design, 2d ed., Prentice-Hall, Inc., Upper Saddle River, N.J., USA, 2007, the disclosures of which are incorporated by reference herein.

In step 375, a determination is made as to whether the new parametrized representation has significantly changed from the parametrized representation obtained in earlier iterations. If so, the matrix T is updated in step 380 using components from the new parametrized representation. The decision to update the matrix T in step 375 may be based on the prior knowledge about image components and parametrized representation of the current solution.

If the new solution g^{k+1} is significantly different from old solution then the components (e.g., heart, lung. etc.) of the known structures may be aligned (registered) with the current image using, for example, an affine transformation or using simulations and known structural properties of the object being imaged. This aligning of an image with a known structure could also be done interactively by a human operator using a keyboard, mouse, joystick and a display.

Other techniques which could be used for this alignment are described in, for example, O. Camara et al., “Explicit Incorporation of Prior Anatomical Information into a Nonrigid Registration of Thoracic and Abdominal CT and 18-fdg Whole-Body Emission PET Images,” IEEE Trans. Medical Imaging, 26(2):164-178, February 2007; and Terry S. Yoo, Insight into Images: Principles and Practice for Segmentation, Registration, and Image Analysis. AK Peters Ltd, 2004, the disclosures of which are incorporated by reference herein.

The known structures could be determined based on data obtained from a database. The known structures could be obtained using a mathematical model. The parameters of this mathematical model could be, for example, determined using a second image of the object being imaged. This second image of the same object could be obtained using a different imaging modality. Examples of such pairings of modalities include, for example, PET/CT, PET/MRI, SPECT/CT, and SPECT/MRI.

The registered components may then be suitably perturbed (e.g., by applying translations, rotations, shear and other deformations) to include additional candidate image components. The matrix T can then be updated using these components while discarding the earlier components in T that are no longer useful.

Additionally or alternatively, the image may be decomposed into several candidate image components represented by mathematical formula. These image components are then suitably perturbed (e.g., by applying translations, rotations, shear and other deformation) to generate additional candidate image components. The matrix T is updated using all these components.

Once the matrix T has been updated, the columns of the matrix PT may have to be normalized again to unit variance. This may be done by re-running the estimation of W as described with reference to step 303 above.

The algorithm proceeds to the next iteration (either after updating T in step 380 or directly from step 375 if T is not updated) by returning to step 310 as discussed above. The algorithm iteratively improves the overall quality of the current solution and finally outputs a solution (in the form of x^{k} and g^{k}) in step 325 when a stopping criteria is met (see step 320 above), such as when the iteration number exceeds a threshold on number of iterations.

It should be noted that the computational expensive steps of the algorithm are (i) computation of the vector PTg from the input vector g and (ii) computation of the vector T^{T}P^{T}r from the vector r. As discussed above, however, both these steps may be parallelized to run efficiently on high-performance parallel systems comprising many processors.

Thus, illustrative embodiments of the present invention give better results than other methods by providing a way to simultaneously consider different image components while doing reconstruction. Since the final solution is sparse, the exemplary reconstruction algorithm may select the image components that are most relevant to the observer.

An illustrative embodiment of the present invention can use a combination of transforms (also called basis functions) such as a DCT basis, HAAR transform basis and other Wavelet basis, coverlets etc., and can also utilize prior information about the object to be imaged by including candidate image components in its sets of basis functions.

Unlike conventional reconstruction algorithms, an illustrative embodiment may advantageously leverage spatial smoothness, contiguity information or other known structural properties of the object under investigation for a more accurate reconstruction. For example, an illustrative embodiment may also utilize spatial continuity by incorporating of parametric representation of an intermediate image in order to improve the quality of the reconstructed images.

An illustrative embodiment of the present invention may be iterative, fast and parallelizable. Such an embodiment improves the image quality successively at every iteration and can be stopped at any iteration if the solution quality is found acceptable. Moreover, an illustrative embodiment may be particularly well-suited for systems where the projection matrix P is very large and cannot be stored in memory. As heretofore discussed, in one embodiment, the algorithm requires no information about the projection matrix P, but rather relies on two basic sub-routines: one to compute Px given x as its input and the other to compute P^{T}y given y as its input.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Such a system may include distinct software modules (for example, a partitioning module executing on a hardware processor). Furthermore, aspects of the present invention may take the form of a computer program product embodied in one or more computer readable medium(s) having computer readable program code embodied thereon.

Additionally, the techniques as heretofore described can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 4, such an implementation employs, for example, a processor 410, a memory 420, and an input/output interface formed, for example, by a display 430 and a keyboard 440. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer). The processor 410, memory 420, and input/output interface such as display 430 and keyboard 440 can be interconnected, for example, via bus 450 as part of a data processing unit 460. Suitable interconnections, for example via bus 450, can also be provided to a network interface 470, such as a network card, which can be provided to interface with a computer network, and to a media interface 480, such as a diskette or CD-ROM drive, which can be provided to interface with media 490.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 490) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

A data processing system suitable for storing and/or executing program code can include at least one processor 410 coupled directly or indirectly to memory elements 420 through a system bus 450. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 440, display 430, pointing device, and the like) can be coupled to the system either directly (such as via bus 450) or through intervening I/O controllers (omitted for clarity).

Network adapters such as network interface 470 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 460 as shown in FIG. 4) running a server program. It will be understood that such a physical server may or may not include a display and keyboard.

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on a tangible computer readable storage medium. The method steps can then be carried out using the distinct software modules and/or sub-modules of the system, as described above, executing on a hardware processor. Further, a computer program product can include a tangible computer-readable storage medium with code adapted to be executed to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICs), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for reconstructing an image, the method comprising steps of:
obtaining a measurement in a first domain;
generating an estimate of the image in a second domain based at least in part on the measurement;
generating a sparse representation in a third domain based at least in part on the estimate;
performing one or more iterations until the estimate is determined to satisfy one or more image quality criteria, a given iteration comprising steps of:
generating a projection in the first domain based at least in part on the sparse representation;
updating the sparse representation based at least in part on the projection; and
updating the estimate based at least in part on the sparse representation; and
outputting the estimate determined to satisfy the one or more image quality criteria for use as the image;
wherein the steps are performed by at least one processor device.

2. The method of claim 1, wherein generating a projection in the first domain based at least in part on the sparse representation comprises the steps of:
computing a representation in the second domain as a function of the sparse representation and a first array; and
computing the projection in the first domain as a function of the representation in the second domain and a second array.

3. The method of claim 2, wherein the sparse representation is at least one of generated and updated based at least in part on the measurement in the first domain and the second array.

4. The method of claim 2, wherein at least a portion of at least one of the first and second arrays represents a known structure within an object being imaged.

5. The method of claim 4, wherein the at least one known structure within the object being imaged is determined based at least in part on a second image of the object being imaged.

6. The method of claim 5, wherein the image is obtained using a first imaging modality and wherein the second image is obtained using a second imaging modality.

7. The method of claim 6, wherein the first and second imaging modalities are selected from a group consisting of Positron Emission Tomography (PET), Single Photon Emission Computed Tomography (SPECT), Computed Tomography (CT), Magnetic Resonance Imaging (MRI), Nuclear Magnetic Resonance Imaging (NMRI), and High-Resolution Research Tomography (HRRT).

8. The method of claim 2, wherein at least a portion of at least one of the first and second arrays represents one or more mathematical transforms.

9. The method of claim 2, wherein the estimate is updated based at least in part on the sparse representation and the first array.

10. The method of claim 2, wherein updating the estimate further comprises a step of updating the first array.

11. The method of claim 10, wherein updating the first array is responsive to a determination that a criterion related to the sparse representation has been satisfied.

12. The method of claim 11, wherein updating the first array comprises steps of:
aligning at least a portion of the estimate with at least one known structure in an object being imaged;
perturbing the aligned structure to generate one or more candidate image components; and
replacing at least a portion of the first array with at least one of the one or more candidate image components.

13. The method of claim 12, wherein at least a portion of the aligning is performed through manual manipulation of at least one of the at least a portion of the estimate or the at least one known structure.

14. The method of claim 11, wherein updating the first array comprises steps of:
decomposing at least a portion of the estimate into one or more candidate image components;
perturbing the one or more candidate image components of the image to generate one or more additional candidate image components;
replacing at least a portion of the first array with at least one of the one or more candidate image components.

15. The method of claim 1, wherein updating the sparse representation based at least in part on the projection comprises generating a back-projection.

16. The method of claim 1, wherein updating the sparse representation based at least in part on the projection comprises steps of:
determining a direction of improvement; and
moving the sparse representation in the direction of improvement.

17. The method of claim 16, wherein the direction of improvement is determined based at least in part on a function of the projection and the measurement.

18. The method of claim 17, wherein determining the direction of improvement comprises computing at least one of a gradient and a sub-gradient of the function of the projection and the measurement.

19. The method of claim 17, wherein determining the direction of improvement comprises thresholding the determined direction of improvement to comply with at least one constraint.

20. The method of claim 17, wherein moving the sparse representation in the direction of improvement comprises at least one of a multiplicative update and an additive update.

21. The method of claim 20, wherein moving the sparse representation in the direction of improvement comprises thresholding the determined updated sparse representation.

22. The method of claim 21, wherein moving the sparse representation in the direction of improvement comprises repeating the updating and thresholding steps.

23. The method of claim 1, wherein at least one of the image quality criteria is based at least in part on a number of iterations performed.

24. An apparatus for reconstructing an image, the apparatus comprising:
at least one memory; and
at least one processor device operative to perform steps of:
obtaining a measurement in a first domain;
generating an estimate of the image in a second domain based at least in part on the measurement;
generating a sparse representation in a third domain based at least in part on the estimate;
performing one or more iterations until the estimate is determined to satisfy one or more image quality criteria, a given iteration comprising steps of:
generating a projection in the first domain based at least in part on the sparse representation;
updating the sparse representation based at least in part on the projection; and
updating the estimate based at least in part on the sparse representation; and
outputting the estimate determined to satisfy the one or more image quality criteria for use as the image.

25. A computer program product comprising a tangible computer readable recordable storage medium including computer usable program code for reconstructing an image, the computer program product comprising computer usable program code for performing steps of:
obtaining a measurement in a first domain;
generating an estimate of the image in a second domain based at least in part on the measurement;
generating a sparse representation in a third domain based at least in part on the estimate;
performing one or more iterations until the estimate is determined to satisfy one or more image quality criteria, a given iteration comprising steps of:
generating a projection in the first domain based at least in part on the sparse representation;
updating the sparse representation based at least in part on the projection; and
updating the estimate based at least in part on the sparse representation; and
outputting the estimate determined to satisfy the one or more image quality criteria for use as the image.
